(19) United States
(12) Patent Application Publication
(10) Pub. No.: US 2009/0260061 A1
(43) Pub. Date: Oct. 15, 2009

(54) SYMBIOTIC NETWORK DIGITAL DOCUMENT LAYERING AND/OR STEGANOGRAPHY METHOD, ARTICLE AND APPARATUS

(76) Inventor: Thomas W. Lynch, Austin, TX (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 12/102,771

(22) Filed: Apr. 14, 2008

(51) Int. Cl. H04L 9/32; G06F 21/24

(52) U.S. Cl. 726/3; 726/27; 726/30

(57) ABSTRACT

What is provided are methods, articles and apparatuses for digital document layering, watermarking holding messages, and/or general steganography over a symbiotic network.

### BACKGROUND

This disclosure relates to digital document layering, watermarking holding messages, and/or general steganography over a symbiotic network.

Authenticating and verifying computer messages is an important task. Encryption and other methodologies are often utilized to make and keep the contents messages private. Encryption schemes and these other methodologies are under constant attack by those wishing to circumvent these protections. What is needed is additional capabilities designed to thwart prying eyes.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is a schematic diagram illustrating an example embodiment of a symbiotic computing system;

FIG. 2 is a schematic diagram of an example embodiment of an alternative symbiotic computing system;

FIG. 3 is a flow chart illustrating an example embodiment of a steganographic method that may be used in a symbiotic network;

FIG. 4 is a flow chart illustrating an example embodiment of a steganographic method that may be used in a symbiotic network;

FIG. 5 is a flow chart illustrating an example embodiment of a steganographic method that may be used in a symbiotic network;

FIG. 6 is a table showing a example embodiments of test and alias vectors;

FIG. 7 is a block diagram illustrating various example embodiments of symbiotic relationships;

FIG. 8 is a directed graph illustrating another example embodiment of a symbiotic network;

FIG. 9 illustrates an example embodiment directed to equalizing knowledge flow;

FIG. 10 illustrates an example embodiment of symbiotic archival; and

FIG. 11 is a flow chart illustrating an example embodiment of a steganographic method that may be used in a symbiotic network.

FIG. 12 is a flow chart illustrating an example embodiment of a steganographic method that may be used in a symbiotic network.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Unless specifically stated otherwise, as apparent from the following discussion, it is appreciated that throughout this specification a computing platform includes, but is not limited to, a device such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instruct a computing platform to perform a certain action it is understood that instruct may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may include an end-user.

Flowcharts, also referred to as flow diagrams by some, are used in some figures herein to illustrate certain aspects of some embodiments. Logic they illustrate is not intended to be exhaustive of any, all, or even most possibilities. Their purpose is to help facilitate an understanding of this disclosure with regard to the particular matters disclosed herein. To this end, many well known techniques and design choices are not repeated herein so as not to obscure the teachings of this disclosure.

Throughout this specification, the term system may, depending at least in part upon the particular context, be understood to include any method, process, apparatus, and/or other patentable subject matter that implements the subject matter disclosed herein.

Authenticating and verifying a grouping of data elements is an important task. Encryption and other methodologies are often utilized to make and keep the contents of a grouping of data elements private. Encryption schemes and these other methodologies are under constant attack by those wishing to circumvent the protections offered. What are needed are additional capabilities designed to thwart prying eyes.

Sometimes it may be desirable to hide a secret message by using a first public message as a cover. For example, providing a first document that may be viewable to members of the public, but imbedding a second secret document with the public having limited access to the first document. Access to the first document may be granted upon authentication and/or in response to an initiating event. Members of the public may not know that the second document exists. However, authorized persons knowing of its existence may gain access thereto by execution of an initiating event, such as, for example, by an authentication.

There are many kinds of data sets and documents. A non-exclusive list of documents may include historical accounts, diaries, pedagogical works, entertaining works, schedules, lists, official statements and proclamations, currency, stocks, certificates, titles, and registrations. An individual may use a document to augment his own memory, for example when making a grocery list. Two people can communicate through a document, for example in a letter. One individual may communicate with a group through a document, for example, by writing a book or a patent. Also, a group of people can communicate together through a document, for example through a bulletin board. Documents can be used to assert authority, as for citations, stock certificates, titles of ownership, and currency, for example. Documents may be private as with a letter, secret like the Atlantic Charter, or public as is the case for newspapers. Documents may communicate written words, pictures, diagrams, charts or other content. Of course, these are merely example types of documents, and the scope of claimed subject matter is not limited in these regards.

As used in this specification, the term document is not intended to be limited to the specific examples discussed above, or to paper media. The term document is not intended to be limited to an official writing, but can be any communication however seemingly trivial—such as a mere doodle. A message may constitute a portion of, or all of, a message content of a document. A data set may include a portion of or all of a message content of a document. For example, a document could include a paragraph of text. A message from that document could include a sentence of text, and a data set of that document could include a word of that text. For example, a document could include a single character, and the message and the dataset from that document could also constitute that single character. Documents, messages and data sets, as used herein, are intended to broadly include paper, electronic, or any other media, and include words, pictures, objects, communications and/or other content. Claimed subject matter is not intended to be limited to these particular examples—these are merely possible embodiments.

As used herein, a first layer document may also be referred to as a first layer message and/or a layer one document or message. Similarly, a second layer document may also be referred to as a second layer message and/or a layer two document or message, and so on for further layers.

Due at least in part to the difference in physical media between paper and electronic media, and due at least in part to the potential ease and cost of distribution associated with electronic media, technologists have struggled to recover the versatility of paper documents in the digital world. Digital media may more easily facilitate public communication than conventional paper documents in that, for example, it may be distributed en mass quickly. For example, a cork bulletin board holding papers with push pins may generally be able to reach a smaller scale audience and hold a smaller scale volume of content, than the Internet may provide.

However, digital media may not adeptly facilitate some things that may be done with conventional documents. For example, stamping or signing a digital document can be a complex activity electronically, while conventionally this may be done with the swipe of the hand. Trustworthiness of a purported document source and authentication may be more complex electronically. Communicating electronic documents over the Internet privately or securely, without exposing them to being read by the general public or unintended viewers, may be more difficult and less reliable than just sending a document via the post or a parcel delivery service, in terms of security.

Further, in terms of document authentication, stamps and/or embossed seals may be added to a document in order to make a document official. An official document may be one which was created by an official party, and other parties holding the document may not be allowed to change it. For example, birth certificates and corporate charters may be published with an embossed seal. Some documents may be notarized. Signatures and such embossed seals may be meant to authenticate a document rather than to provide information content. Information content, such as the birth date and name, or the company inception date and name, may be conveyed in the document itself.

Some conventional documents carry watermarks rather than signatures, stamps, embossing, etc. In some cases a watermark can be created simply by writing on the paper with water, thus causing the clay in the paper to thin. This process can be accelerated with a steam process and a metal template. Such a water mark can be read by holding the paper to the light. Chemicals and other manufacturing processes can also be used to place watermarks on paper. Some watermarks can not be seen with the naked eye, and instead the paper must be placed in a solution, sometimes water, for the mark to become visible. This type of water mark may depend upon the paper having variable solubility. Other watermarks may not appear to the naked eye under normal lighting conditions, but may be viewed with a special light, such as a black light. There are many types of conventional watermarks, and historically, effort has been devoted to making them more trustworthy so as to better protect document authenticity.

Unlike a stamp or embossing, the watermark may be embedded in the paper, and the document writing may be placed over the top of it. The watermark may not take up any print space. This may allow those who make watermarks to place more information in the mark.

Steganography may generally be the art of putting hidden messages in documents. The classic example is that of lemon juice used as invisible ink over the top of another letter. If the paper is heated, the hidden message may become legible. Ostensibly, nobody but the reader may know to do this. Steganography may be used to reduce or avoid drawing attention to the hidden document. A document obviously written in code may invite scrutiny, if for no other reason than the curiosity of the document holders or processors. In contrast, a state secret overlaying a bible may sit on the book shelf in a parlor unnoticed for years, for example. Further, steganography may be used to carry a message rather than for document authentication.

A layered document may be one form of a steganographic technique. In a layered document, the top layer of the document may be somehow removed, thus exposing another message. The second message may be hidden until the first layer is removed. Simple examples of this include looking at the back of a hanging picture, or removing a water soluble layer of paint to reveal another picture. These are merely examples ways to hide a second message. Many more possible techniques exist.

Various steganography techniques described herein may be used in a symbiotic network. In general, a symbiotic network may be a network of different computers having a membership predicate and which allows dataset sharing among symbiotic partners. Prior to access being given to a data set, a verification may be performed to verify that the system seeking access is a symbiotic partner of the system owning the dataset. This verification may be a symbiotic pairing verification. In a symbiotic network, one or more datasets may be shared in a partial or full manner over a number of machines or user accounts. These datasets may be managed through symbiosis, or in a hybrid manner with other types of transactions between the entities on the network. Example embodiments of symbiotic networks are discussed below, however, claimed subject matter is not intended to be limited to the particular examples illustrated herein.

As used herein, a first layer document may describe a document that may be directly read by a viewer. It may be generally publicly available or its distribution limited. Within the distribution audience, in some embodiments the ‘message’ in a first layer document may not be a secret, and as such, no unusual process from the point of view of the symbiotic network user is gone through to access this data. In the steganographic lemon juice example, the first layer document may be the one that the person sees before applying heat. In the water mark context, the first layer document may be the one printed with usual ink.

As used here, a second layer document may be one which can be viewed only after some process is gone through. It may be a message one might see in slightly burned paper after applying heat in the stenographic lemon juice example. It may be a message that can be read after paper is, for example, placed in alcohol solution in the watermark reading process. In the digital context, a second layer document may not be obviously there when accessing a first layer document, but rather may appear after some additional process is gone through. In the digital realm, a document may have any number of steganographic layers. Degree of effectiveness in an ability to hide a second layer document (or further layer documents) may lie within what process is followed in order to read the second layer message and its complexity.

In other embodiments, the first layer document may be viewable only to an authorized audience and some process, such as symbiotic pairing verification, may need to occur prior to viewing the first layer document. In this type of embodiment, the second layer document may only be viewable upon execution of a further authentication, such as an initiating event or another type of verification to ensure that the viewer attempting to access the second layer document is authorized to do so. In this sense, the intended and authorized audiences for the first and second layer documents may be coextensive, overlapping, subsets of one another and/or partially or completely different. The intended audiences of different layer documents may be independent of one another in various embodiments.

First and second layer documents may be layers of a single document or separate documents. In various embodiments, the layers may be transmitted together, with access to the second layer withheld until an initiating event occurs. Or, in other embodiments, upon occurrence of an initiating event, the second layer document may be transmitted. Similarly, in various embodiments, documents having more than two layers may be handled in like fashion. However, these are embodiments and claimed subject matter is not intended to be so limited.

First and second layer documents may contain related content, or they may contain independent content, in terms of what is being communicated therein. For example, a second layer document may contain authentication information to authenticate the content of the first layer document. Or a second layer document may contain a secret message that the unrelated first layer document is meant to cloak. For example, the first layer document may communicate public content related to secret information about that public content, which is hidden in the second layer document. Again, these are merely examples and claimed subject matter is not so limited.

First and second layer documents may be accessed simultaneously (once access to the second layer document is granted), or upon granting access to the second layer document, the first layer document may be destroyed or rendered un-viewable in some embodiments. Many access limitations are possible and claimed subject matter is not so limited.

In symbiosis for archival, a data set could be shattered, with fragments of the data set going to symbiotic partners, rather than the whole of the data set. Shattering may be a breaking of a dataset into multiple pieces or parts and distributing the pieces to different systems within a symbiotic network. Shattering may create a situation where a symbiotic partner with a sub critical fragment could not recover the original data set in a straight forward manner. A redaction operation may be employed to create a critical fragment set, or to put the data set back together in straight forward manner. This is discussed in more detail below.

Host authentication on a symbiotic network may include a membership predicate. Within this network, data sets may be built or formatted so that symbiotic partners can authenticate each other.

As discussed in more detail below, stamping within a symbiotic network may include methods for signing, stamping, and embossing digital documents on a symbiotic network for purposes of authenticating documents. A result of an authentication query may be the result of the authentication decision. However, in the current state of the art for symbiosis there is no manner, method, or process for supporting higher layer messaging. Hence, methods and apparatuses for higher layer messaging are introduced in this application. In some embodiments, a result of an authentication query may be access to a second or further layer document.

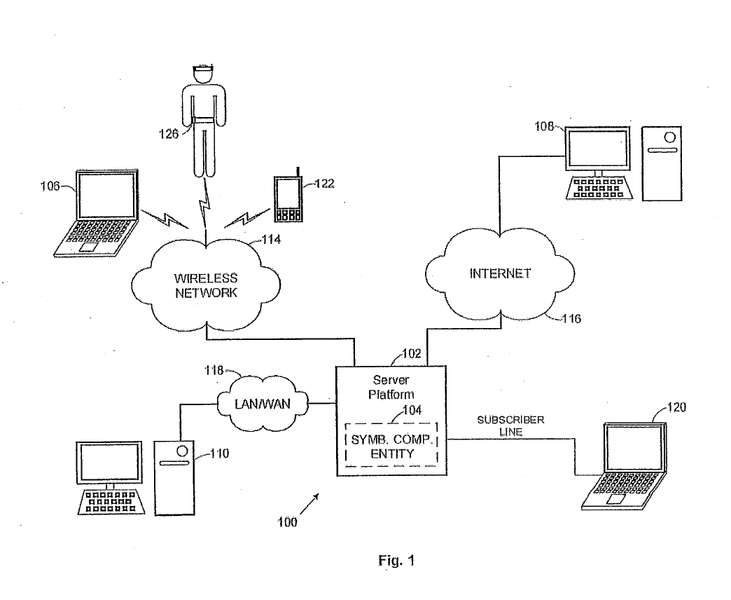

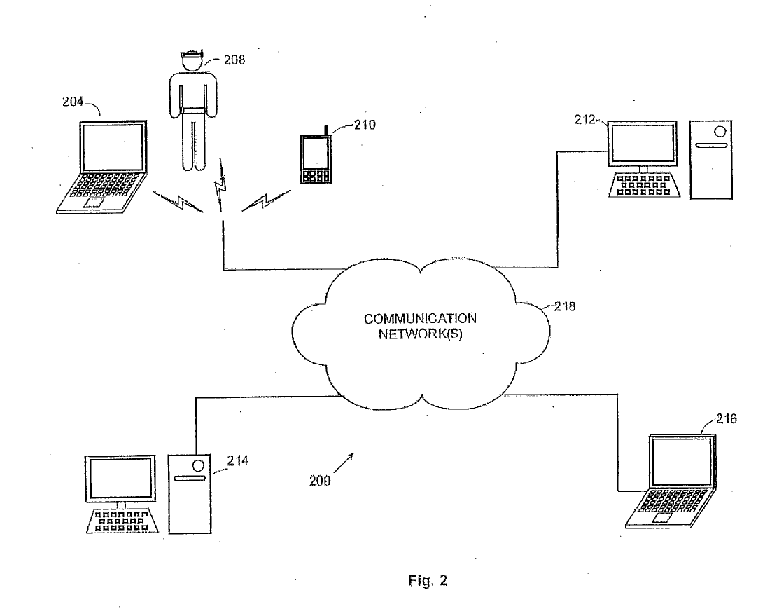

FIGS. 1 and 2 depict example embodiments of symbiotic networks. These are discussed in more detail below.

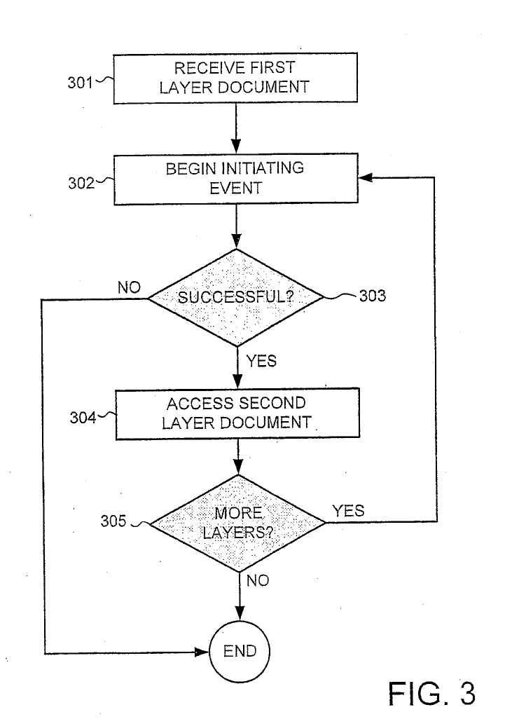

FIG. 3 is a flow chart depicting an embodiment of a steganographic method which may be employed in a symbiotic network. At block 301, a document may be received. This document may be a first layer document. In some embodiments, it may be a first layer document and include a second layer document that is hidden and/or not accessible prior to occurrence of an initiating event. In some embodiments, it may include a first layer document and two or more hidden layer documents. A recipient may be a person and/or a device, in various different embodiments. A recipient may not know that there exists a second layer document, and/or may not know to take and/or successfully complete an initiative. In different embodiments, a document may transfer between owners or recipients any number of times before a recipient takes an initiative to read a second layer or other hidden layer document.

The term “owner” does not necessarily communicate that the recipient owns the document in terms of title or legal ownership. While the recipient may “own” the document, the term “owner” is meant to be used interchangeably with recipient, holder and/or possessor. Likewise, recipient may be used interchangeably with owner, holder and/or possessor, and is merely meant to convey the person or apparatus having the document at least temporarily in hand.

In various embodiments, in response to receiving the document, it may be read, stored and/or displayed, for example. Other actions may be taken with the first layer document. The document may be distributed solely to the party sending it and in that sense, involve only one party. Distribution may also be between two or more parties and a document may be distributed multiple times between or among various parties. The distribution may be to a public audience or to a limited audience. These are merely examples of possible distribution and actions possibly taken with a first layer document and claim subject matter is not so limited.

In various embodiments, the first layer or first document may be accessed, viewed, stored and/or displayed prior to occurrence of an initiating event. Some embodiments may allow access, storage and/or display of the first document and/or layer for an unlimited time prior to initiating the initiating event to gain access to the second document and/or layer. In some embodiments, there may be an expiration feature, such that there is a predetermined time within which the initiating event must take place to gain access to the second document and/or layer. Again, these are merely examples and claimed subject matter is not so limited.

At block 302, an initiating event may begin. In some embodiments, the initiative may begin in response to receipt of the document. In other embodiments, it may be begun at a later time. For example, it may be that a recipient does not realize that a second layer document exists until after a time period. For example, it may be that a recipient does not realize that the message has urgency at a later date, and does not begin an initiating event until that time. In some embodiments it may automatically begin and in other events, the initiative may not take place until manual intervention begins the initiative. In some embodiments, an initiative to access a second layer document may be made at any time and other embodiments may include an expiration period, after which access to a second layer document is denied. Claimed subject matter is not limited to these particular examples.

At block 303, a determination may be made as to whether or not the initiating event completed successfully. For this embodiment, in some instances an initiating event may be completed successfully and in other instances, it may fail. For example, a recipient that begins an initiating event may be mistaken about the action(s) needed to successfully complete the initiating event. A recipient may also be mistaken about whether a second layer document exists. A recipient may attempt to access a second layer document, but take incorrect actions to begin or complete an initiating event. In some embodiments, access to the second layer document is not given until completion and/or success of the initiating event. But in other embodiments, access to the second layer document may be given upon initiation of an initiating event. Claimed subject matter is not limited to these particular embodiments.

An initiating event may include one or more various tasks or happenings in different embodiments. In some embodiments, an initiating event may include document authentication of the first layer document. This authentication may comprise, for example, stamping and/or watermarking, some embodiments of which are described below. An initiating event may comprise successful entry of a password. An initiating event may comprise host authentication. An initiating event may include verification that the sender is a symbiotic partner and/or that the received message contains symbiotic partner sent data. An initiating event may include an external protocol. For example, an authorized viewer of the second layer document may know to complete one or more actions unrelated to the document to gain access thereto. An initiating event may include user intervention or a recipient system may automatically begin an initiating event in response to receipt of a layer one document. An initiating event may include various combinations of different events. Initiating events may vary use to use, and/or increase in complexity upon previous initiating event failure. These and many other possibilities exist within the scope of claimed subject matter, and these specific examples and various embodiments are not intended to limit claimed subject matter.

If the initiating event did not successfully complete, in this embodiment, access to the second layer document is not given. In some embodiments, the recipient may be given multiple attempts to complete the initiating event. In other embodiments, the number of allowed attempts may be limited, and/or the complexity of the initiating event may increase upon failure. Other embodiments may not require completion of the initiating event for second layer document access, but rather may give access upon start of an initiating event. These are merely possibilities and claimed subject matter is not so limited.

At block 304, access may be given to a second layer document in response to a successful completion of the initiating event. If the second layer document is accessed, a recipient may read, store and/or display the second layer document, or take other actions with the document, in various embodiments. Some embodiments may limit allowable actions that may be taken with the second layer document. For example, some embodiments may prohibit editing, printing and/or transfer of the second layer document. In some examples, if access to the second layer document is granted, the recipient may be allowed unlimited access and/or unlimited actions may be taken with a document. Access may have limits, such as an expiration period after which the recipient must complete one or more subsequent initiating events to access the document again. Another example is that if a user closes a second layer document, an initiating event may need to be completed again before the user may subsequently view the document. This may be the same initiating event or a different initiating event. However, these are merely examples in various embodiments and claimed subject matter is not so limited.

In some embodiments the document may include one or more meta markings indicating presence of the second document layer (and/or further document layers) and/or association of a second document and/or layer (and/or further document layers) to a first document. However, claimed subject matter is not so limited. In other embodiments, the document may not include metadata.

In some embodiments, the second document may be transmitted to a computing platform upon occurrence of an initiating event. In other embodiments, it may be transmitted with the first document, but not accessible until occurrence of an initiating event. However, these are merely examples in various embodiments and claimed subject matter is not so limited.

Layered documents may include more than two layers, such that access to third and/or subsequent layers may be granted upon occurrence of the initiating event or upon occurrence of one or more further initiating events. At block 305, an inquiry may be made as to whether there are more layers to a document. If there are more layers, the authentication process may be repeated for accessing further layers. There may be different intended audiences for different document layers, and users having authorization to view one layer may not have authorization to view one or more other layers. In other embodiments, second layer document audiences may have access to some or all further layers as well. Some embodiments may allow for access attempts to further document layers, even if an initiating event did not successfully complete for a second layer document and if access to the second layer document was denied. These are merely possibilities and claimed subject matter is not so limited. As shown in FIG. 3, if further layers do not exist, the method may end. Example processes in accordance with claimed subject matter may include all, more than all, or less than all of blocks 301-305. Further, the order of blocks 301-305 is merely an example order, and the scope of claimed subject matter is not limited in this respect.

In various embodiments, one or more initiating events may comprise user identification, machine authentication and/or document verification.

### Symbiotic Networks

FIG. 1 is a schematic diagram illustrating an embodiment of a symbiotic computing system. In the embodiment depicted, a network of computing platforms may be implemented as described, for example, in U.S. Pat. No. 6,931,430; Maintaining Coherency in a Symbiotic Computing System and Method of Operation Thereof; by Thomas W. Lynch; filed May 12, 1999, and, without limitation, be employed or adapted to implement identification and/or authentication in a symbiotic computing system. A symbiotic computing system, such as 100, may include a plurality of computing platforms, any or all of which may reside physically near and/or apart from the other computing platforms. A symbiotic computing system may include a computing platform, such as a server platform, as shown by way of non-limiting example at 102, laptop computing platforms, such as 106 and 120, desktop computing platforms, such as 108 and 110, a wearable computing platform, such as 126, and a hand-held computing platform, such as 122, to name but a few of the many possibilities. Computing platforms 102, 106, 108, 110, 120, 122 and 126 may couple to and/or otherwise network with any or all of the other computing platforms via various communication links now known or to be later developed. A symbiotic computing system illustrated by 100 may be commonly referred to by some as a client/server system, although the scope of claimed subject matter is not limited in this respect. For example, other systems in addition to client/server systems may comprise symbiotic networks. However, in such a client/server system, a server platform, such as 102, may, for example, provide server operations to the other computing platforms which may operate as clients. Server operations may include, but are not limited to, serving as a repository for some and/or all of the data for a network. Similarly, server platform 102 may perform in a manner commonly associated with a gateway. For example, it may pass operations between members of a symbiotic network without intervention. In such a role, server platform 102 may be termed a symbiotic gateway. Server platform 102 may, by way of non-limiting example, provide file storage functions, communication and/or broadcast functions, database functions, and/or various other functions typically provided by a server, though the scope of claimed subject matter is not limited to these examples. A computing platform such as a server platform as shown by way of non-limiting example at 102 may also perform network management functions, including, but not limited to, managing the resources of one or more associated client computing platforms.

Communication links, such as those illustrated, for example, may have their own characteristics. For example, laptop computing platform 106, wearable computing platform 126 and hand-held computing platform 122, may couple to a computing platform such as server platform 102, which may itself comprise a network of computing platforms, for example. Although, the scope of the subject matter disclosed herein is not limited in this regard. Coupling may occur through a medium such as via a wireless network 114, however, claimed subject matter is not limited in scope to wireless coupling. Nonetheless, a wireless network, such as 114, may allow laptop computing platform 106, wearable computing platform 126, and hand-held computing platform 122, to be mobile, yet maintain relatively low bandwidth communications with a server platform, such as 102. Further, a desktop computing platform, such as 108, may couple to server platform 102 via a communications medium, such as the Internet, shown as 116. Similarly, desktop computing platform 110 may couple to a server platform, such as 102, via a Local Area Network (LAN) and/or a Wide Area Network (WAN). Internet 116 and a LAN/WAN, such as 118, may provide relatively higher bandwidth connections but may also provide little or no mobility benefits. Moreover, laptop computing platform 120 may couple to server platform 102 and/or any other computing platform capable of providing server-like operations. For example, this may be accomplished via a subscriber line, such as, for example, an Integrated Services Digital Network (ISDN), Asynchronous Digital Subscriber Line (ADSL) or Plain Old Telephone Service (POTS) line, although, again, the scope of claimed subject matter is not limited to these examples.

The computing platforms in the depicted embodiment may have resident thereupon a symbiotic computing entity. While a symbiotic computing entity, such as 104, is shown resident upon 102, symbiotic computing entities may also be resident upon 106, 108, 110, 120, 122, and 126, but are not explicitly shown in FIG. 1. As explained herein, the symbiotic computing entities may be executed via instructions, such as software instructions, upon available or modified hardware components and/or by customized hardware components, although the subject matter claimed is not limited in this respect.

FIG. 2 is a schematic diagram of an embodiment of an alternative symbiotic computing system. As compared to system 100 of FIG. 1, the symbiotic computing system, shown at 200, does not include a server platform such as that depicted by FIG. 102. Thus, in system 200, symbiotic relationships may be established between peer computing platforms to maintain coherency of managed resources that may be included on one or more of the peer computing platforms. Such peer computing platforms may include, by way of non-limiting example, laptop computing platforms, such as 204 and 216, desktop computing platforms, such as 212 and 214, a wearable computing platform, such as 208, and a hand-held computing platform, such as 210. Peer computing platforms such as 204, 216, 212, 214, 208 and 210 may communicatively couple to one or more communication network(s), such as for example, 218.

Symbiotic relationships may be established amongst symbiotic partners comprising a symbiotic computing system to, at least in part, perform a symbiotic operation, as described in more detail hereinafter. Generally, a computing platform purporting to be a symbiotic partner may attempt to initiate a symbiotic computing session with an established symbiotic computing platform. A purported symbiotic computing platform may also be referred to as a requester, initiator, originator, and/or external computing platform. These terms are intended to be used interchangeably. Likewise, an established symbiotic computing platform may identify, and/or authenticate, for example, the requestor as a legitimate symbiotic partner, also referred to herein more simply as a symbiotic partner. A computing platform being asked to, for example, authenticate a purported symbiotic partner may be termed herein, by way of non-limiting example, as an established or known symbiotic computing platform, network member, or symbiotic partner. A requester may be considered remote as to a challenger but need not be. Further, as the computing platform being asked to grant a connection to a requesting system, an established symbiotic computing platform, may for example, in a role as a challenger, transmit to a requester, a challenge designed to, at least in part, establish the requester as a symbiotic partner to the challenger. A challenge may comprise, though is not limited to, a query to generate a response from a requester.

An example of such a query may include, though is not limited to, confirming or verifying data in a symbiotic dataset shared by the symbiotic computing platforms. Further, a challenge may comprise, but again, is not limited to, a query phrased as an operation to be performed by a requester with the results of performing the operation, for example, on a symbiotic dataset, being returned for identification and/or authentication purposes. An example may include, but is not limited to, providing the results of applying a hash operation to the symbiotic dataset and reporting the result. If the result that is reported if verified, a challenger may accept a requester as a symbiotic partner and the two computing platforms may establish a symbiotic relationship so as to perform one or more symbiotic operations. A collection of symbiotic computing platforms working as symbiotic partners may be termed a symbiotic computing system and/or a symbiotic computing network or more simply a symbiotic system and/or symbiotic network, although the scope of claimed subject matter is not limited in this respect.

As previously mentioned, a symbiotic computing system may include a plurality of symbiotic partners that may be communicatively coupled. A symbiotic partner may be employed to, for example, manage a data resource, as described in more detail hereinafter. A managed data resource may include, but is not limited to, data entities, such as data files, data bases, data sets, configuration files and/or source files, for example. However, a managed resource may also include other types of data resources such as, by way of non-limiting example, video images, symbiotic relationship configurations, applications, executables and other data resources. The contents and organization of a data resource at a particular point is referred to as an instance or instantiation of the particular data resource at that point. Alterations made to an instance of a managed data resource may be made to other instances of the managed data resource to, for example, maintain coherency between instances or instantiations.

A symbiotic partner may, for example, implement management of a resource via a symbiotic computing entity. As will be discussed more fully below, one or more symbiotic partners may, for example, receive data or other information that potentially affects a respective instance of a managed data resource. A symbiotic partner may, for example, produce an action based, at least in part, upon the received data or information. For example, such an action may result in modification of the particular instance of the managed data resource. Such an action may thus be transmitted to a symbiotic partner and converted locally to a command and thereby affect a local instance of a managed resource. A symbiotic computing platform may also package and transmit an action to another of the symbiotic partners. Another of the symbiotic partners may thus receive the action, convert it to a command consistent with the local resources, and use the command to affect a respective instance of the managed resource to, for example, maintain coherency of the managed data resource, although claimed subject matter is not limited in scope in this respect. Thus, actions may, for example, be used to transmit changes to a managed data resource and/or transmit operations that give rise to changes.

If establishing a symbiotic relationship amongst symbiotic partners, managed resources may be synchronized to at least in part, by way of non-limiting example, ensure that a common starting point exists. From a common starting point, an instance of a managed data resource may be processed or changed based at least part, for example, on application of a program or by a user. Actions to be applied to a symbiotic partner may, for example, be generated from user inputs or from a program, for example, to be applied to another symbiotic partner, although the scope of claimed subject matter is not limited in this respect. Such actions, for example, may be converted to commands that may be received by an application program which may thus be used to operate upon a managed resource, although, again, the scope of claimed subject matter is not limited in this respect.

Generally, actions pass between symbiotic partners to maintain a managed resource and passing actions may maintain the symbiotic relationship, and thus enhance data security. Further, symbiotic actions may enhance data security. For example, assuming for the purposes of discussion, that an action is snooped and/or intercepted, the action alone is not sufficient to reconstruct the managed data resource, for example. Further, because coherent versions of a managed data resource may reside upon multiple symbiotic partners, data availability and/or data reliability may also be enhanced.

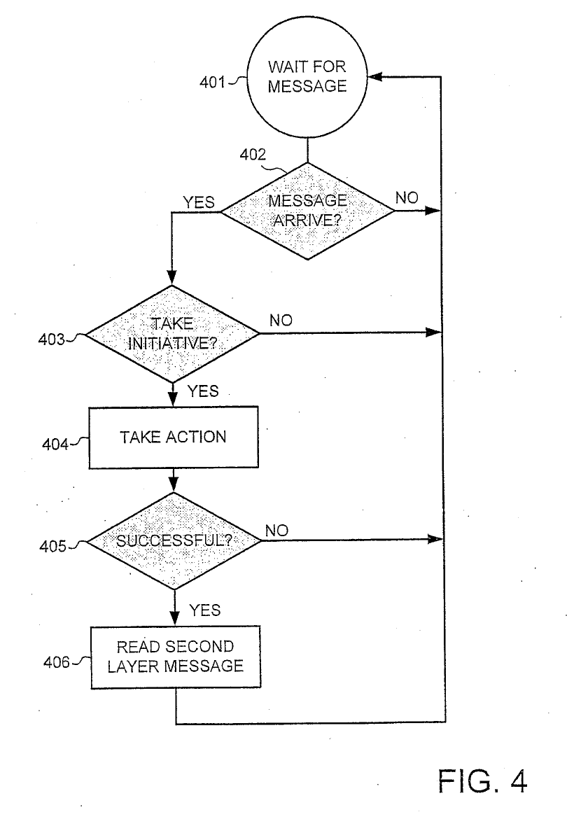

FIGS. 4-6 will be discussed below.

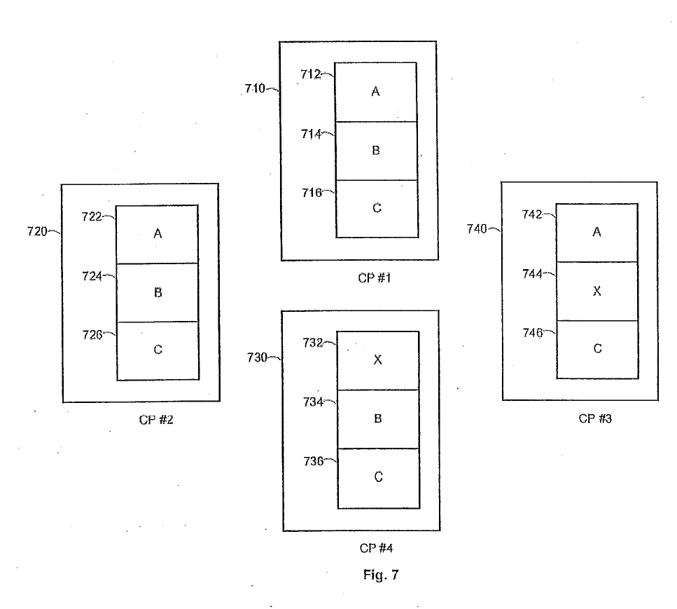

FIG. 7 is a block diagram illustrating various embodiments of symbiotic relationships. For example, systems 710, 720, 730, and 740 may hold one or more instances of a data managed resource. Managed data resources depicted herein as 710, 720, 730, and 740 may include, for example, Datasets-A, B, and/or C, although the scope of claimed subject matter is not limited in this respect. Further, the datasets may comprise data that may be unique to the members of a symbiotic relationship. By way of contrast, data that may not comprise symbiotic dataset may include an ASCII code chart and/or the windows operating system, for example. In other words, these are examples of data that one may expect to be resident on computing platforms that are not members of a symbiotic network, for example.

Symbiotic relationships may be symmetric or asymmetric. In a symmetric symbiotic relationship, actions may be created by both of a set of two symbiotic partners to affect a managed resource. Therefore, by way of non-limiting example, systems 710 and 720 may be mutually symmetric. Similarly, a symmetric symbiotic relationship may exist between system 710 and 740 at, for example, Dataset-A, such as at 712 and 742. Thus, an action applied to, for example, 712 by system 710 may be communicated to 742 as an action and system 740 may apply a similar action to 742, although the scope of claimed subject matter is not limited in this regard. Further, all of the systems depicted in FIG. 7 may be symmetric on, for example, Dataset-C, such as at 716, 726, 736, and 746. However, again, claimed subject matter is not constrained in this regard. Failure by any partner in, for example, a fully symmetric relationship may mean that the failed partner becomes unable to transmit or receive actions with respect to other of the symbiotic partners. Failure may include, but is not limited to, a communications channel being unavailable. Recovery from such failure may, depending on the particular embodiment, for example, be achieved in a variety of ways. For example, actions from a failed symbiotic partner may be buffered locally and transmitted after the partner recovers from the failure. Similarly, actions to be received by a failed partner may be buffered remotely and transmitted if recovery is verified. Alternatively, should failure continue beyond some threshold, for instance the tolling of a timer, the symbiotic partner may be flagged as removed or dropped from the symbiotic network until and unless some higher order of recovery may be implemented to assure a desired level of coherency, although claimed subject matter is not limited in this regard. Coherency amongst symbiotic partners may be re-established by re-synchronizing managed resources as may be appropriate. Resynchronization may also be used if an instance of a managed resource becomes corrupted.

Time related management issues as they apply to coherency and corruption of a managed resource are well known in the relevant art. They include, for example, but are not limited to, received actions being applied to an instance of a managed resource according to their time stamps. Similarly, semaphores may be implemented so that one symbiotic partner may alter an instance of a managed resource at a time, although the scope of claimed subject matter is not constrained in this manner. Should inconsistencies appear between instances of a managed resource, a symbiotic computing platform may attempt to reconcile such inconsistencies. An attempt to reconcile apparent inconsistencies may include, but is not limited to, reordering actions with or without including undoing previous actions. Alternatively, and without limitation, a receiving partner may notify a sending partner of apparent or latent inconsistencies and request that the sending partner retransmit actions with or without reordering them, although the scope of claimed subject matter is not limited in this respect.

Data sets may further be kept in synch by implementing a symbiosis validation entity and/or functionality. Such an entity and/or functionality may receive actions and attendant overhead information and evaluate whether or not data sets may further be kept in synch on a local instance of a managed resource should a given action be implemented. Similarly, a coherency checking entity and/or functionality may be implemented that may verify coherency by using, for instance, CRC checks and/or checksums, though the scope of claimed subject matter is not limited to these examples.

Symbiotic computing may be established in any of many various network architectures or network configurations. For example, without limitation, a symbiotic computer system, for example, may reside within a client/server environment, or a peer-to-peer environment, as previously discussed, and/or in an object oriented environment, among others. Additionally, symbiotic computing may, for example, facilitate relatively low bandwidth management of resources by generally communicating actions, but not data.

In establishing symbiotic operation within a symbiotic computing system, synchronization among instances of a managed resource may be desirable. Symbiotic relationships may be defined such that data may be received by one or more of the symbiotic partners. After the relationships are defined, operations may continue to maintain coherency of instances of a managed resource. However, problems in operation caused by, for example, computer outages, software bugs, computer failures, network problems, inconsistent actions and/or any other problems may indicate that a problem exists with maintaining coherency. If such problems occur, checks may be performed to determine if the symbiotic computing system is operating properly. If not, recovery may be initiated so that instances of a managed resource may again become coherent. After this is completed, operation may continue. If inconsistent actions and/or problems occur, other techniques, some well known in the art, may also be employed to move forward in the operation of the symbiotic computing system without initiating a full recovery operation. Such techniques may modify a managed resource using a set of rules or by rejecting, for example, one or more inconsistent actions, though, again, claimed subject matter is not limited in scope in this respect.

In an embodiment, it may be useful to know, for example, that a message was sent by another member of the symbiotic computing network; though it may not be as important to know specifically which member sent the message. A member of a symbiotic network may be referred to, in some contexts, as a symbiotic partner, although claimed subject matter is not limited in scope in this respect. Resolving which computing devices comprise legitimate members of a symbiotic network may be referred to, for example, as resolving the membership predicate, although claimed subject matter is also not limited in this respect. Likewise, in an embodiment, symbiotic partners may, for example, share a symbiotic dataset. This may comprise, for example, minimal, partial, or full symbiosis. In this context, identification of a symbiotic partner may include, but is not limited to, an existing symbiotic system requesting a purported symbiotic system to provide information verifying its identity as a member of the symbiotic network or system. This may include, for example, a process whereby a computing platform matches a set of qualities or characteristics that uniquely identify another computing platform with those expected, for example, of the another computing platform.

For example, but without limitation, in different embodiments of a symbiotic computing system, operations may comprise logical and/or mathematical operations including a cyclic redundancy check and/or a hashing function. Similarly, alternative embodiments may, for example, challenge a requestor to perform multiple operations upon a dataset. Likewise, a challenge may be constructed in an alternative embodiment requesting a splatter pattern listing bit indexes in the dataset to be returned for verification. Still another embodiment may request a set of finite difference coefficients to a pattern generator for finding bit indexes be returned, though, again, claimed subject matter is not limited in scope to these described embodiments. A further embodiment may include returning pseudo randomly chosen bits scattered over a data set. If such data is transmitted, such data will not on its face provide meaningful information to a listener. Eventually, if enough challenges were spied upon, the dataset may become known. By way of comparison, it is observed that, random bit selection is analogous to bit permutation which is often performed in various encryption techniques. Concomitantly, running data through a hashing function or sending a CRC similarly may make data less intelligible.

Further embodiments include, but are not limited to, issuing a challenge wherein the existing symbiotic network member, for example, Sys-A in the immediately preceding example, requests not just data and/or that operations be performed upon the data, but that the computing platform requesting a connection provide information about the data in the dataset. By way of non-limiting example, this may include, but is not limited to, requesting information about the position of data in the dataset. Data may for example, include, but is not limited to, not only the coding for data elements, such as ASCII coding, but also, without limitation, may include the data conveyed by any such coding such as, for example, the letter “a.” Furthermore, and/or alternatively, Sys-A may request time stamps associated with specified data, and/or request information relating at least in part to any of the properties and/or metadata associated with the data. As a further, non-limiting, possibility, metadata associated with data may specify that a function be evaluated and/or the function to be performed upon the data. Such operations or variations of such operations may be performed upon data and lend themselves to processes of identification and/or authentication if they can be reliably and verifiably performed on either end of a session. As will be apparent to those skilled in the art, any and/or all of the above may be implemented in an embodiment; however, claimed subject matter is not limited in this respect.

A further alternative embodiment may include a dataset and/or section of a dataset whose purpose, at least in part, may be for use in identifying a symbiotic partner. One benefit, among many, of such a dataset is that a non-symbiotic partner snooping and/or spying upon the network may not be aware of the value of such data, likely complicating efforts to illegitimately access the network and/or establish a link with a symbiotic partner. In an embodiment, identifying a system as either a symbiotic partner or an imposter may comprise uniquely identifying the identity of a computing platform and/or entity. Alternatively, in another embodiment identifying a computing platform as either a symbiotic partner or an imposter may comprise, without limitation, generally identifying a purported symbiotic partner generally as a symbiotic partner, but not specifically establishing its identity, that is, which specific symbiotic partner it is, as will be explained below.

In these contexts, authentication, may include, but is not limited to, determining a system's identity and may as well comprise determining what that system is authorized to do, such as for example, what that system is permitted to access, as a simple example. In an embodiment, a system may establish that it is a symbiotic partner, for example, with another system, as to a given dataset but that may not, necessarily, mean that after authenticated the system joining with the established symbiotic computing platform has unlimited privileges as to any of the established symbiotic partner's resources. In an embodiment, should a purported symbiotic partner be identified as a legitimate symbiotic partner but, for example, attempt operations on a symbiotic partner that exceed the permissions granted, such an attempt may, for example, trigger a system response similar to that encountered if an unknown or illegitimate computing platform attempts to connect or couple to an existing symbiotic computing platform. The process of authentication may comprise applying a set of rules. Authentication may be strengthened by establishing certain times at which authentication may be allowed to occur, although claimed subject matter is not limited in scope in this regard. The process of authentication may comprise authentication queries and/or challenges, for example.

Embodiments are not limited to running membership predicates and/or issuing challenges once. Such actions may occur after some number of transactions, accesses, accesses of a certain class, and/or period of time, to name a few of the many possibilities. Further, in an embodiment, one symbiotic partner may be able to verify another symbiotic partner to a network, while in another embodiment, each symbiotic partner may have to verify itself to each symbiotic partner with which it interacts. However, the scope of claimed subject matter is not limited in this respect.

Legitimate members of a symbiotic network may be referred to, in some embodiments, as symbiotic partners. A symbiotic partner may include some and/or all of a dataset included by another symbiotic partner. In another embodiment, a symbiotic partner may comprise a user account. In an embodiment, a user account may comprise an account established by a system administrator, for an individual user, on an individual machine. However, in at least one alternative embodiment, in keeping with claimed subject matter, for example, a user's account may be spread across some number of computing devices. An example of this may include a personal data assistant (PDA) including a user's list of personal contacts, while a desktop computer may include the user's business contacts, and a personal entertainment device (PED) may include a play list of the user's favorite songs. Collectively, in an embodiment, these may comprise an implied user account, which may be treated as a symbiotic partner.

In an embodiment, an implied user account may employ, for example, partial symbiosis. Partial symbiosis may be where datasets are fully or partially shared with a subset of symbiotic partners. In one embodiment, a symbiotic partner may include distinct unary partial symbiotic relationships with each of the symbiotic partners it may care to later identify. Similarly, these symbiotic partners may operate in a similar fashion. That a pair of symbiotic partners share a dataset or a partial dataset may not preclude them from having a full or partial symbiotic relationship on other datasets and/or parts of other datasets. As is the case with other symbiotic partners, an embodiment may use a forward identification method and/or a reverse identification method, depending, for example, upon the particular embodiment.

In one embodiment, a symbiotic partner, herein referred to as Sys-1 may have symbiotic partners Sys-2 and Sys-3, for example. They may have a partial, pair wise, symbiotic relationship with each other in that they may not each have a full version of the others' data. Perhaps, for purposes of illustration, for example, Sys-1 has a partial symbiotic relationship with Sys-2 and Sys-3; Sys-2 has a partial symbiotic relationship with Sys-1 and Sys-3; and, Sys-3 has a partial symbiotic relationship with Sys-1 and Sys-2. In a short-hand style, this may be denoted as: Sys-1 (12, 13, 21, 23), Sys-2 (21, 23, 13, 32), and Sys-3 (31, 32, 13, 23) wherein the first digit in a pair may denote a data generator and the second digit in a pair may denote a data destination, although claimed subject matter is not limited to any particular approach. Data generators may comprise all of the data that they have generated though this is not a requirement. As described in more detail below, this notation may allow one to reduce these systems to equivalent systems of symbiotic networks. Therefore, {Sys-1 (12), Sys-2 (12)}, {Sys-1 (21), Sys-2 (21)}, {Sys-1 (13), Sys-3 (12)}, {Sys-1 (31), Sys-3 (31)}, {Sys-2 (23), Sys-3 (23)}, {Sys-2 (32), Sys-3 (32)}. Wherein, each of these pairs may describe communication between two distinct user accounts and, for this embodiment, no two distinct pairs share the same dataset. Therefore, once the system resolves the pair to which the processes and/or methods of membership predicates are to be applied, such processes and/or methods may be employed, though claimed subject matter is not constrained or limited in scope to any particular approach.

In still another embodiment, pair-wise unique data sets may not be fully present in a collection of possible symbiotic partners. Therefore, in such an embodiment, multiple partial symbiotic datasets may be used for identification. This embodiment may use distribution vectors. A distribution vector, in this context, generally refers to data comprising parts which may have native data, which has been distributed to symbiotic partners via the symbiotic network. An element in the vector may comprise a one or a zero, for example, however, claimed subject matter is not limited in this respect. An element may be set to one if the symbiotic partner has a version of the dataset. In an embodiment, for example, suppose there are four symbiotic partners on a symbiotic network: S0, S1, S2, S3—accordingly, a distribution vector may have four components. This may result in a system of vectors such as: S0(s0):{1,0,1,1}; S1(s1):{1,1,0,1}; S2(s2):{1,1,1,0}; S3(s3):{0,1,1,1} describing a situation where symbiotic partner S0 may have distributed a dataset to S2 and S3 as well as maintaining a version. The data set may be called s0. S1 has a dataset called s1, which may have been distributed to S0 and S3 while maintaining a version. S2 has a data set called s2 which has been distributed to S0 and S1. S3 has distributed s3 to S1 and S2.

For the purpose of illustration, suppose that S0 would like to identify S2. There is no unique data set which may be isolated. However, S2 may be unique to S0 because it has in common with S0 datasets s0 and s2. Thus, one membership identification predicate application against s0 may narrow down the identification to the set {S1, S2}. A second membership predicate application against s2 may, in this example, narrow the possibilities down to just S2. Thus, identification in the absence of unique pairing may be achieved by performing two membership predicate applications in this example embodiment.

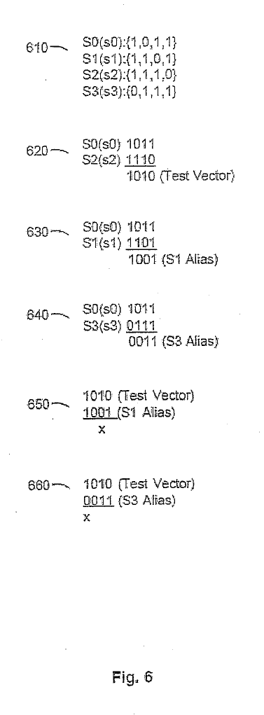

Turning back to FIG. 6, FIG. 6 is a table showing an embodiment of test and alias vectors. The foregoing discussion may be generalized against the distribution vectors, reproduced at 610, in the following fashion. The host distribution vector, S0(s0) as described above for this example, may be written first and then below this the distribution vector for the party to be identified, S2(s2) also as described above. A logical operation, such as, for example, an AND operation here, may be performed going down the column to create a test vector, as shown at 620. For each 1 in the test vector, in this embodiment, though claimed subject matter is not limited in scope in this respect, a membership predicate may be employed. This procedure may be repeated for other members of the network producing alias vectors, as illustrated at 630 and 640, though the scope of claimed subject matter is not constrained in this regard. Pair wise comparisons of these alias vectors against a test vector may be performed, as illustrated at 650 and 660. If a test vector is a subset of an alias vector, an aliased host may be illegitimate and may be attempting to spoof a network member. In the embodiment, as illustrated at 650 and 660, for example, there can be no aliasing.

If an identification predicate fails, as in the forgoing example, one may assume a spoofing attempt. In an embodiment, it may be noted what data was used in the failed identification attempt. In the case of reverse identification predicates, an embodiment may avoid reusing this data as a spoofer may take advantage of multiple attacks to learn more about this data. Alternatively, an embodiment may purposefully reuse data that resulted in a network interloper, such as a spoofer, having failed in an attempt to connect to a system and possibly again block a similar later attempt, although the scope of claimed subject matter is not limited in this regard. Similarly, data accumulated from failed attempts to join as a symbiotic partner, regardless of whether resulting from a forward and/or reverse membership predicate, may be shared with other symbiotic partners. Therefore, and without limitation, a failed attempt as a symbiotic partner may result in more careful evaluation of partners or result in a response, such as a report or an alarm, for example, to other partners.

FIG. 7 additionally depicts another embodiment. In an asymmetric symbiotic relationship, one of a set of two symbiotic partners, for example, may create actions that affect a managed data resource, although the other may not. An example of this includes, but is not limited to, if a computing platform such as system 710 may create actions affecting any of its managed resources on 720, but where its symbiotic partner, here, for example, system 720 may not be capable of applying or executing such actions. In an embodiment implementing this aspect, system 720 may, by way of non-limiting example, be used to shadow the managed resources of system 710 and provide for a coherently matched copy of these managed resources, here datasets A, B, and C. Similar to a symmetrical symbiotic relationship between systems at a given managed resource, as described above, an asymmetrical symbiotic relationship may exist between systems at the level of a single managed resource. For example, again system 710 may share a symbiotic partnership with system 740 at managed resources 712 and 742, respectively. However, in contrast to a symmetrical symbiotic partnership, they may have an asymmetrical symbiotic relationship such as where, for example, an action at 742 may change the resource and be communicated to 710; however, an action at 712 will affect neither 712 nor 742, however, claimed subject matter is not limited in scope in this regard. Additionally, in accordance with the forgoing, a symbiotic relationship may be established between multiple symbiotic partners having both symmetric and asymmetric components as to different instances of managed resources.

A symbiotic relationship may also be “minimal,” “partial,” or “full.” In a minimal symbiotic relationship managed resources occurs precisely twice in the network, while being resident on different machines. It is possible for a quite large network constituting many machines to be considered minimal from a symbiosis point of view. If no more than two machines are involved, it follows that the symbiotic relationship may be minimal. A minimal symbiotic relationship may exist, for example, between systems 710 and 720. A partial symbiotic relationship over a managed resource may exist if there are more than two occurrences, but there are fewer occurrences than the number of symbiotic partners. A non-limiting example of such a network may include systems 710, 720, and 730, but not 740, although the scope of claimed subject matter is not limited in this regard. A full symbiotic relationship may exist for a managed resource if all partners within a network include an occurrence of the managed resource. An example of this is illustrated by including all of the systems 710, 720, 730, and 740 illustrated in FIG. 7 in a symbiotic network. It is also possible for a symbiotic network to be less than minimal. However, some of the advantages of using symbiosis in such situations may be reduced. It is also possible for a symbiotic network to be more redundant than full. A symbiotic network may also comprise, for example, without limitation, a virtual and/or logical network where although some and/or all partners may be communicatively coupled to one or more of the others they may, nonetheless, share assigned and/or defined relationships. Further, any and/or all symbiotic relationships may, for example, be symmetric or asymmetric as previously described.

Further, a symbiotic relationship between symbiotic partners may be “pure” or “hybrid.” In a pure symbiotic relationship, actions may be passed between symbiotic partners, for example, without limitation, the actions operating via an application to affect a managed resource. In an embodiment, for example, system 740 and system 730 may comprise symbiotic partners at 746 and 736 respectively, which may comprise a dataset, although the scope of subject matter claimed is not constrained in this regard. Actions received at either may be communicated to and acted upon by the other. In a hybrid symbiotic relationship actions as well as other operations and/or exchanges may be passed between symbiotic partners. For example, system 730 and system 740 may communicate actions pertaining to a shared managed resource, such as 736 and 746 respectively, but they may also, without limitation, engage in other exchanges, such as, including without limitation, data updates, for instance. These operations and/or exchanges may further include, for example, file downloads and/or other transfers that may be initiated based at least in part upon user input but may be implemented in lieu of actions. Additional advantages of utilizing symbiotic actions include, but are not limited to, reducing network traffic by, for example, engaging in transactions employing less network traffic to implement than typical file transfers.

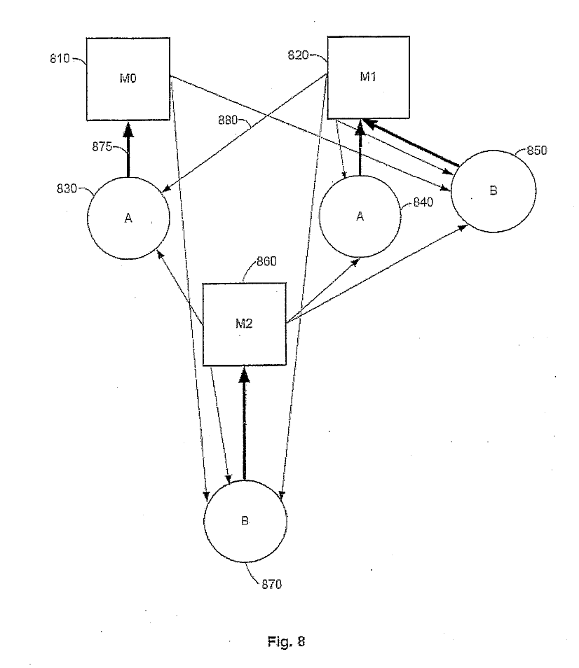

A symbiotic network may be described using a special form of directed graph such as that shown by FIG. 8. FIG. 8 depicts two types of nodes: machine nodes and managed resource nodes. The machine nodes, 80, 81, and 82; 810, 820, and 860 respectively, are shown as squares. Managed resource node “A,” depicted as separate instances 830 and 840; and managed resource node “B,” similarly depicted as separate instances 850 and 870 are shown as circles. FIG. 8 also depicts two types of arcs; locality arcs, and action flow arcs. If a managed resource is hosted locally on a machine, a locality arc, depicted in the figure as the thicker of the two illustrated arc styles, extends from the managed resource to a hosting machine. Such a relationship may be depicted, by way of non-limiting example, by locality arc 875 illustrating a relationship between a machine node such as 810 and a managed resource such as shown at 830. An instance of a managed resource may be given a name, for example “A” or “B.” If two managed resources are symbiotically identical, they may have the same name. Action flow arcs are depicted as extending from a machine node to a managed resource node if that machine can send actions that affect that managed resource. Where a managed resource is local to a given machine, that local machine may be able to mitigate the flow of actions to that managed resource. Two machines are said to have an asymmetric relationship, if they have resident an ostensibly matched managed resource, described above as managed resources that may share the same name, but do not both have action flows to the other's managed resource node. Machines 810 and 820 diagram a non-symmetric relationship on managed resource A. 820 may affect 810's managed resource A, such as shown at 840, and illustrated by arc 880. However, 810 cannot affect 820's managed resource A, such as shown at 840, and illustrated by the absence of an arc between 810 and 840. Similarly, 810 may have an asymmetric relationship with 860 over managed resource “B” depicted at 870. 810 can affect 860's managed resource B, such as shown at 870, but 860 can not affect 810's managed resource B, as machine MO shown at 81 0 does not have an instance of managed resource B. In this latter example, where 810 does not have an instance of managed resource B, we may call this special case ‘asymmetry without ownership.’ Note, in well formed symbiotic networks, instances of an ostensibly same managed resource, such as those described above as managed resources that may share the same name, may be affected with actions from any given machine that may affect any one of them. It is understood throughout that instances of ostensibly the same managed resources comprise managed resources that are intended to be the same as each other. Such managed resources may not necessarily, however, be identical to each other at all moments at time such as if, by way of non-limiting example, an update has been affected at one copy of the managed resource but has not yet been affected at another copy of the managed resource.

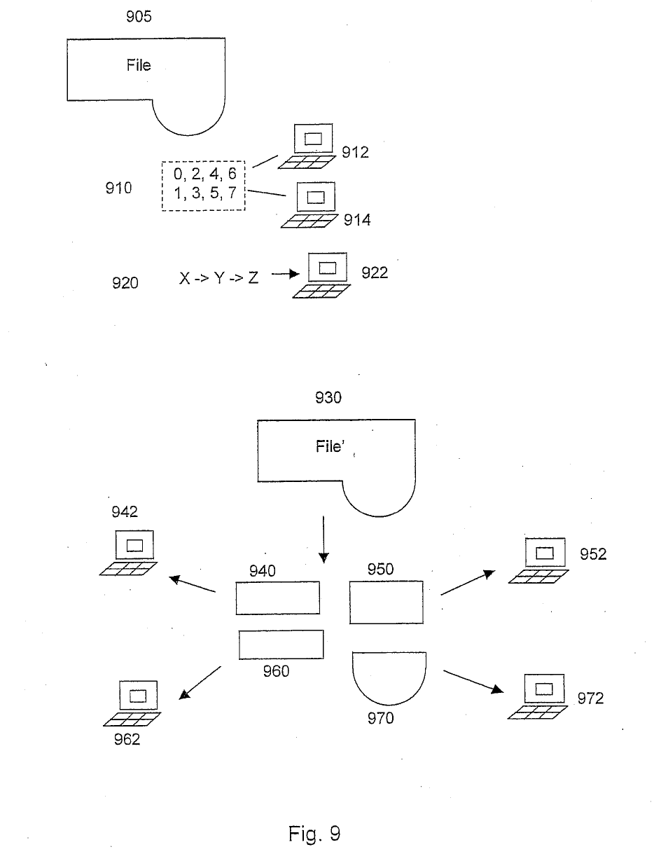

FIG. 9 illustrates an example embodiment directed to equalizing knowledge flow. Equalized knowledge flow may, though it is not the only way to, provide the capability to authenticate a document. For purposes of discussion, we can describe an example situation where a sergeant, such as at 910, writes an order for supplies and gives, such as at 915, this written supply order to a private, such as at 920, though the claimed subject matter is not limited in this respect. The private 920 may then take the written order to a supply center and present the written order, such as at 925, to a supply clerk, such as at 930. However, the private 920 may have forged the written order and/or modified it. Forgery may be controlled for, in some degree, by requiring that the written order be signed by the sergeant. Signing a document may be a form of stamping a document such as when hot wax may have been melted over the seal of an envelope and then imprinted with an image known to belong to a certain party. However, an unauthorized modification may be more difficult to spot and prevent. Some of the vulnerability of this transaction flows from the unequal knowledge flow as between the private 920 and the clerk 930. The private 920 knows what the written order included when it was given to the private 920 by the sergeant 910 but the clerk 930 does not. The private 920 may, potentially, exploit this disparity of knowledge by modifying the written supply order to include an item or items not requested by the sergeant 910. In a situation where a post-transaction audit, such as at 935 be performed the sergeant 910 must take the time to reconcile what was asked for by the sergeant 910 and what was delivered by the supply clerk 930. Of course, this example using military personnel is merely an example, and of course the scope of claimed subject matter is not limited in this respect. The present example is intended for illustrative purposes.

One way to control for a disparity of knowledge may be for the sergeant 910 to call the supply clerk 930 by phone and tell the supply clerk what to expect on the written order, such as at 940. Should the sergeant 910 tell the clerk 930 what to expect 940, neither the private 920 nor the supply clerk 930 may be in a position to easily insert a fraudulent copy of the written supply order. Of course, the preceding exchange is described only for purposes of illustration and the scope of the claimed subject matter is not constrained to only this example. In the preceding example, the role of the sergeant 910 may variously be described as that of a document owner, issuing agent, stamping agent, and/or generating agency, to list but a few of the many other equally descriptive terms, though the scope of the claimed subject matter is not limited in this respect.

In an embodiment, the sergeant 910 may provide the private 920 an electronic copy of the supply order for presentation to the supply clerk 930. The sergeant 910 could even call ahead and tell the supply clerk to expect a private to present a supply order. It is the possession of the document that identifies the holder of the document, here, for example, not as “a” private, but as “the” private 920. Authentication of the supply order may be facilitated where the sergeant's computing platform is symbiotically connected with the supply clerk's computing platform, such as by being symbiotic and/or network friends on a symbiotic network, at and/or on the dataset comprising the order for supplies. In such a circumstance, where the clerk's 930 computing platform may be, for example, fully symbiotic with the sergeant's 910 computing platform, the clerk's 930 computing platform may, therefore, check the order directly. We may refer to an embodiment implementing this as implementing a direct method of symbiotic verification, or more simply, as implementing direct verification. Verification may include both direct and indirect verification for one or more embodiments. Verification may comprise the act of reviewing, inspecting, testing, checking, auditing, and/or otherwise establishing and documenting whether items, processes, services, and/or documents conform to specified requirements. The direct method is not constrained to authenticating and/or verifying only documents but may be used, for example, to verify any grouping of data elements. A grouping of data elements may comprise digital and/or analog signals, capable of and/or adapted to being interpreted as representing and/or communicating one or more components of communication and/or data and/or information, although the scope of claimed subject matter is not constrained in this respect. A grouping of data elements may, by way of non-limiting example, comprise a string of ones and zeroes. A digital file may comprise an instance of a grouping of data elements and the scope of claimed subject matter is not constrained in this regard. A document in digital form may comprise a digital file and may be, therefore, an example of a grouping of data elements, although the scope of claimed subject matter is, again, not limited in this respect. A grouping of data elements may comprise a grouping of symbiotic data elements comprising a grouping of data elements residing on one or more symbiotic computing platforms. The teachings of the direct method of symbiotic verification may similarly be applied to, for example, identification, to name but one among many of the various uses that now will be apparent to those skilled in the relevant art. A symbiotically linked computing platform may also be referred to herein as a symbiotic computing entity, symbiotic network friend, symbiotic friend, network friend and/or symbiotic partner, although, again, the scope of claimed subject matter is not limited in this respect.

Returning to the prior example, in an embodiment employing a direct method of verification, for example, supply clerk's 930 computing platform may be fully symbiotic with sergeant's 910 computing platform at the dataset in question. This level of symbiosis may provide the supply clerk a duplicate copy of the document against which to verify. Further, any data element and/or grouping of data elements may be in question here but for purposes of this example a supply order, a document, is described although the scope of claimed subject matter is not limited in this regard.

Upon seeing each other, supply clerk 930 may identify private 920 as the entity expected to be presenting the supply order. For verification purposes, the supply clerk may then identify the supply order as an actual supply order, evaluate the content of the supply order against that which sergeant 910 is authorized to request and verify the presented supply order as being within acceptable parameters and proceed to verify the actual content of the supply order. This same and/or similar sequence of actions may be used in any implementation of symbiotic stamp verification. Direct verification may be accomplished by comparing the copy of the supply order presented by private 920 against a copy of the supply order available to supply clerk 930 from the supply clerk's computing platform, as supply clerk's 930 computing platform and sergeant's 910 computing platform are symbiotically linked on at least this dataset for this example embodiment. In an embodiment, a version of the supply order presented for verification may be considered a potentially stamped version of the supply order which will either be verified as a stamped version of the supply order or determined to not be a stamped version of the supply order by a verification agent, here, supply clerk's 930 computing platform. If the two documents, the copy presented and the copy being used to compare against, are not, for example, a match, the private's copy of the supply order may not be verified as authentic and any of a number of actions may follow, although the scope of claimed subject matter is not constrained in this manner.

Similarly, in a situation where no direct symbiotic link exists between supply clerk's 930 computing platform and sergeant's 910 computing platform on the dataset in question, indirect verification may be implemented. Indirect verification may comprise at least an additional computing platform, such as a third party platform, for example. An additional computing platform may, for example, be fully symbiotic with the sergeant's computing platform on the dataset in question, although this is not a requirement and the scope of claimed subject matter is not limited in this respect. Supply clerk 930 may then take the supply order received from private 920 and submit it to this third party for verification. If the document is authentic this third party in a role as a verification agent may, for example, return a “Yes” verifying that the document is authentic, although the scope of claimed subject matter is not constrained in this respect. In these and/or similar contexts a verification agent may also be termed a symbiotic verification agent, although the scope of claimed subject matter is not constrained in this regard.

In an alternative embodiment, a user may wish to keep the full contents of a document and/or grouping of data elements, such as a digital file for example, secret. Similarly, a user may wish to control the scope and/or manner in which a grouping of data elements may be disseminated. A grouping of data elements may comprise text, drawings, pictures, data, a dataset, signatures, diagrams, logos, decorative art, and/or a fragment of a larger grouping of data elements, by way of non-limiting examples, and further, the scope of the claimed subject matter is not limited in this respect. In such an embodiment, a user may, for example, break a grouping of data elements into smaller pieces, referred to herein as shattering, and then may distribute these smaller pieces, referred to herein as fragments, to other symbiotic computing entities, such as by way of non-limiting example, symbiotic network friends. A fragment may, for example, be the result of breaking a grouping of data elements into odd and even bits. Similarly, a fragment may be the result of some operation, such as applying a hashing function, for example, although the scope of claimed subject matter is not limited in this regard. The output resulting from a cyclic redundancy check may be another example of a fragment. A fragment may then be distributed to one or more network friends. The computing platform initiating these actions may be termed an issuing agent and the process just described may be termed as shattering a grouping of data elements, such as for example a document, but again, the scope of claimed subject matter is not limited in this respect. In an embodiment, a network friend receiving one or more fragments of a grouping of data elements may be unable to recreate the original grouping of data elements in its entirety. This may be especially true where a network friend holds, at the most, only a derivative portion of the original grouping of data elements, such as, for example, only a fragment resulting from operations performed on a sub-critical portion of an original grouping of data elements. Alternatively, network friends symbiotic on a dataset may each run the same shattering algorithm on the shared dataset to create identical stamps. An advantage this may afford may be to reduce the likelihood of a stamp being intercepted. Further, a fragment may or may not have also been subjected to any and/or many forms of processes, including, but not limited to, encryption.

In an embodiment a verification agent may not be privy to what shattering algorithm a grouping of data elements had been subjected to so would have no way to undo the effects even should the verification agent have copies and/or access to all fragments resulting from a shattering operation where every portion of a grouping of data elements may have been rendered as a fragment. Verification agents may not, generally, be concerned with the contents of an original grouping of data elements and solely provide the functions of a verification agent with regard to stamps entrusted to them. Similarly, a verification agent may not have the capabilities and/or facilities necessary to reverse the effects of, for example, shattering and/or encryption. In another embodiment, for example, this may not be the case and a verification agent may be able to reverse the effects of the shattering and/or encryption algorithms and recover, redact, the original grouping of data elements, although the scope of the claimed subject matter is not restricted in this respect. Shattering a grouping of data elements into fragments may be utilized as an archiving method although this is not required, and the scope of claimed subject matter is not limited in this respect. If being used for archiving, a grouping of data elements previously shattered and distributed may later be recovered by retrieving the fragments and reversing the shattering algorithm and any other processes previously applied to the grouping of data elements and thereby redacting the original grouping of data elements. Similarly, and without limitation, processes may be reversed before the grouping of fragments is gathered together and the scope of the claims is not limited in this respect.

For the embodiments described herein, there is no requirement that an entire grouping of data elements be presented to a verification agent for verification. In an embodiment, one or more fragments may be submitted to a verification agent for verification. Advantages of submitting one or more fragments of, for example, a shattered digital file, include, but are not limited to, reducing network traffic by only having to communicate the one or more fragments and being able to use only sub-critical fragments of a larger file for verification. Using only sub-critical fragments for verification has the advantage of not having to further communicate critical portions of datasets and run the inherent risk of losing control over them, although the scope of claimed subject matter is not constrained in this respect. Further, fragments may be distributed among several verification agents so that the verification agents cannot, for example, read a shattered document although the scope of claimed subject matter is not constrained in this regard. In such a circumstance, verification may be probabilistic in that some, though not all, possible verification agents holding a symbiotic fragment may be contacted for verification. In an embodiment, multiple verification agents may hold the same and/or different fragments for purposes of verifying a given grouping of data elements. A verification agent may comprise a system and/or a service, for example.

In an embodiment, there may be a preliminary identification and/or authentication which may comprise both identification and a determination of privilege, such as for example, access privileges, of, by way of non-limiting example, users, systems, agents, and/or services, although the scope of claimed subject matter is not limited in this respect. Similarly, in an embodiment, authentication may additionally comprise verification and in at least one embodiment verification may comprise authentication.

A computing platform implementing symbiosis may shatter a grouping of data elements, thus creating a one or more fragments, and then send one or more of the fragments to another computing platform. In an embodiment, an issuing agent may register, for example, an entire document and/or alternatively one or more fragments with a verification agent. Registered groupings of data elements, such as, for example, a fragment, may comprise a stamp. Similarly, a fragment subjected to one or more logical functions, such as, for example, a hashing function, may also comprise a stamp. In an embodiment, a stamp may also be referred to a symbiotic stamp. A symbiotic stamp may be employed at least for all of the purposes any other stamp may be employed. For example, sergeant 910 may give private 920 a copy of a supply order which may contain a symbiotic stamp and/or alternatively also give private 920 a separate symbiotic stamp. The sergeant may also only communicate the stamp to supply clerk 930 but not the supply order itself. The stamp may then, for example, be used to verify the supply order. Some receiving computing platforms may be symbiotically linked to the originating computing platform and others not. In either case, a receiving computing platform may act as a verification agent for a received fragment. Verification may include, and is not limited to, confirming that, for example, files comprise certain properties, such as, for example, that they are the correct length, contain the correct number of digits and/or characters, contain the correct digits, contain the correct characters, and/or the correct data is located in the correct position, although the scope of the claimed subject matter is not limited in this respect.

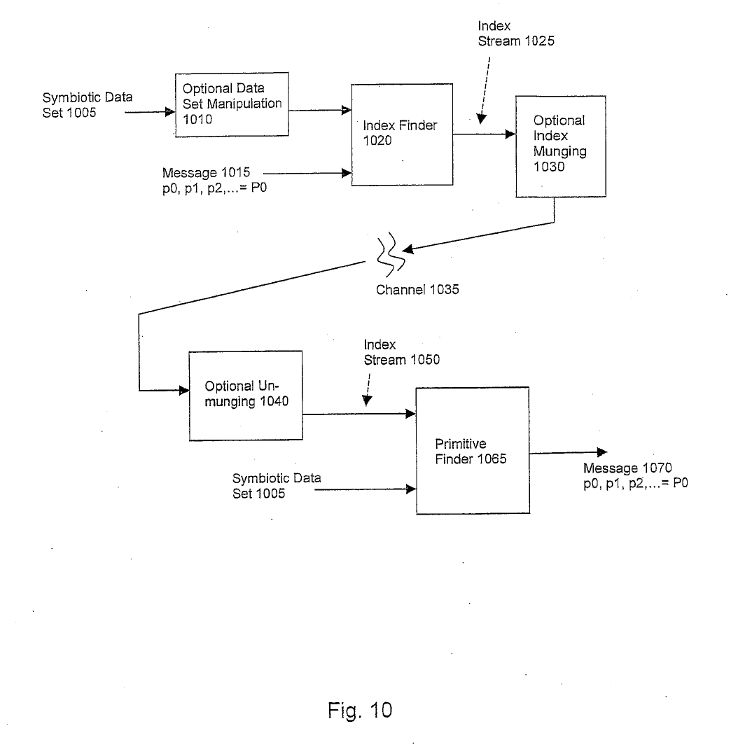

FIG. 10 illustrates an embodiment of symbiotic stamping. The owner of a grouping of data elements, such as the elements depicted as file 1005, may alter the grouping of data elements in any of a number ways prior to, for example, transmitting the grouping of data elements as, by way of non-limiting example, a digital message. The owner of a grouping of data elements may comprise the originator, holder, and/or user of the grouping of data elements. The owner may, for example, cause the grouping of data elements to be split into odd and even bits, such as at 1010, and, also by way of non-limiting example, cause the even bits to be transmitted to a network friend, such as 1012 for example, and cause the odd bits to be transmitted to a different network friend, such as 1014. Network friends 1012 and 1014 need not be on different networks and/or different physical machines and may, for example, be different virtual machines on the same physical machine, although the scope of claimed subject matter is not limited in this respect. Further, the fragments may be transmitted to computing platforms that are not currently on the symbiotic network and/or are not network friends. Alternatively, the odd and even components of the original message may be used as inputs for further manipulations, such as at 1020, though this is not required, and the scope of claimed subject matter is not limited in this respect. At 1020 some version of a grouping of data elements 1005 or a subset of a grouping of data elements 1010 may be represented as version X. Version X of grouping of data elements 1005 may then be subjected to some function, such as a hashing function, to create version Y of grouping of data elements 1005. Further, and without limitation, version Y may subsequently be subjected to some other manipulation, such as for example, an encryption algorithm. There may be no practical limit to how many permutations file 1005 may be subjected to and the scope of claimed subject matter is not limited in this respect. Ultimately, a file, such as 1030, may be produced that may then be shattered into component file fragments, such as 1040, 1050, 1060, and 1070, for example. These fragments may be transferred to network friends for safe keeping and/or other uses, such as to verify a symbiotic stamp, although the scope of claimed subject matter is not limited in this respect. Fragment 1040 may be sent to network friend 1042, fragment 1050 may be sent to network friend 1052, fragment 1060 may be sent to network friend 1062, and fragment 1070 may be sent to network friend 1072 for this example, although the scope of claimed subject matter is, again, not limited in this regard. Beyond the fact that the original grouping of data elements may have been encrypted, none of network friends 1042, 1052, 1062, and 1072 may be able to determine the original grouping of data elements as none of them has a complete copy. Further protection may be afforded the file by, for example, time shifting the transfer of the fragments of the file and/or manipulating file headers, for example, so that no network friend may determine which other, if any, of the possible network friends also holds a fragment of the original grouping of data elements.

An alternative embodiment may shatter a grouping of data elements into fragments before, for example, subjecting the grouping to any manipulations and/or subject different fragments to different manipulations. In an embodiment, an issuing agent may wish to retrieve a grouping of data elements in what may be termed a redacting operation. Redacting a grouping of data elements may comprise, for example, retrieving the fragments and reversing any affects of any processing to render a facsimile of the original grouping of data elements, although the scope of claimed subject matter is not limited in this respect.

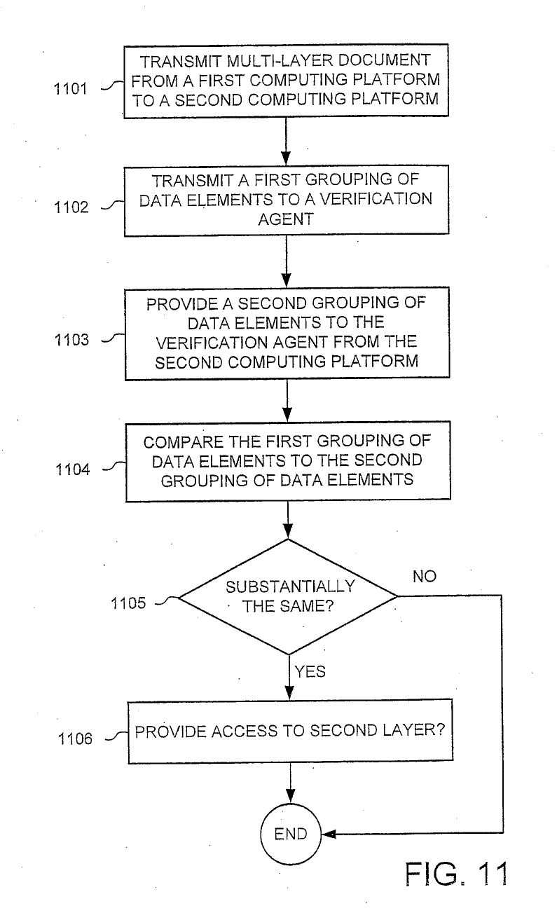

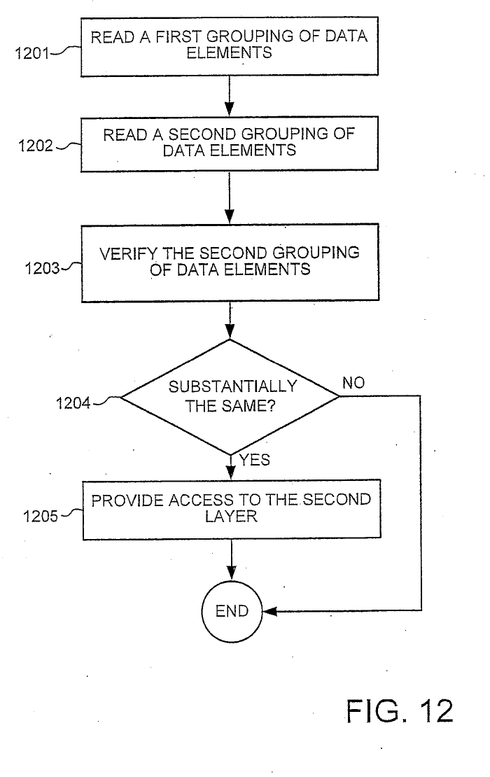

FIGS. 11 and 12 will be discussed in the next section below.

Alternative embodiments may implement access control properties with a grouping of data elements. In one such embodiment, only certain symbiotic network friends are authorized to perform verification. If a grouping of data elements is presented for verification to a verification agent, which may be a network friend, the verification agent may first check to determine if it is authorized to verify this particular grouping of data elements, such as, for example, a fragment. Should the verification agent be, for example, authorized to perform this particular verification it may proceed to implement whatever verification process is suitable in any particular circumstance. However, should the verification agent determine that it is not authorized to verify a particular grouping of data elements, such as a fragment, for example, it may take any of many actions, including, but not limited to, those described herein. For example, it may notify the requesting symbiotic friend that it is not authorized to verify this file, it may return an indication of a failed verification perhaps conveying the impression that the verification procedure was actually run, and/or it may not respond at all, although the scope of claimed subject matter is not constrained in this manner.

Similarly, other properties, perhaps indicated by the nature of the relationship between the computing platform requesting verification and the verification agent being requested to perform the verification and/or properties inherent in the fragments themselves and/or circumstances of the request for verification, may affect the outcome. For example, which and/or how many symbiotic computing platforms comprise a given symbiotic computing network at a given time may affect a determination of which are permitted to perform a given verification. In this or other embodiments it is possible that some symbiotic partners verify only particular fragments having certain characteristics such as size ranges and/or given header properties, for example. By way of further example, fragments may be time stamped when received at a network friend. Subsequently, as part of a verification procedure this time stamp may, for example, be returned to the verification entity providing data which may be used to perform an additional verification check. Similarly, verification may be allowed during certain time windows and out-of-window requests for verification may be either rejected and/or otherwise failed. These examples are listed for illustration purposes, and many other possibilities will now be obvious to those skilled in the relevant art and are not further discussed herein so as not to obscure the embodiments described herein.

These or other verification techniques may constitute one or more initiating events, as described above. After completion of an initiating event, such as these possible authentication techniques, access to a second layer document may be given. However, these are merely examples and claimed subject matter is not so limited.

Further variations are possible. For example, an initiating event may include document verification or authentication of a portion or whole of the document. For example, this may include authentication of at least a portion of the first layer of the document or authentication of the entire document. Authentication may be by stamping authentication, such as that discussed above, or watermarking or archival authentication in various embodiments. Initiating events may be external protocol to the symbiotic network, such as but not limited to, events initiated by a user. Initiating events may include one or more triggering events, which trigger a computing platform to perform an initiating event. Further examples of initiating events include password authentication or host authentication. However, these are merely examples in various embodiments and claimed subject matter is not so limited.

### Further Steganography Embodiments

In one or more embodiments, a second layer document (or layer two message) may be built by extending symbiotic archival. Some examples of symbiotic archival may include the following procedures and/or techniques. First, the user may shatter the data set. Second, fragments may be sent to one or more symbiotic partners. Third, to recover the data set, for whatever reason, a critical set shattered piece may be redacted and the message reassembled. For example, one or more parts of a shattered piece may be authenticated as a redaction event.

In this sense, symbiotic archival and steganography both may include user initiative. User initiative may automatically begin or require user intervention, in different embodiments. In steganography the initiative may be one when the document owner/holder/recipient decides to uncover the second layer document or layer two message. In archival, the user may take initiative if he decides to initiate redaction. In both cases, the result may be a data set (a document could be part of or constitute the whole of a data set). However, general archival may differ from general steganography in that there generally is not a second layer and the user is generally not focused on distributing documents.

In one or more embodiments, second layer capabilities may be added to steganography, and in various embodiments, initiating events may include archival initiatives. In some embodiments, there may be a modified shattering and distributing function which may allow a user to associate a document, data set, or message, with a fragment.

Furthermore, as in symbiotic messaging, one or more fragments may be distributed. In this case, the sender may use a special send routine or a message send routine which has been extended to allow the document association, and which may place one or more meta marks in the data base noting the existence of a second layer document (and/or further layer documents). Once the sender has called this special multilayer send routine, or the extended version for the messaging library, the second layer document may go on to the symbiotic network with the associated fragment. If the recipient recovers the fragment, the recipient may gain access to the fragment (the first layer document information), but may not gain access to the associated second layer document without an initiating event. Again, this is merely one embodiment and claimed subject matter is not limited to this particular example.

In different embodiments, at any time, or within a specified timed period, a recipient of a layer one document may perform a document verification operation as though the fragment of his first layer document were a stamp (symbiotic stamping), such as that described above. In some embodiments, this may be done by using an extended version of the stamping routine from the symbiotic stamping library, or by using a dedicated multilayer ‘initiate( )’ routine. By performing this operation, the recipient may be taking the initiative to recover the next layer document.

If there is no next layer document, in various embodiments, the stamp verification may fail, there may be an error, and/or the recipient may be deemed to be less trustworthy in some manner by the symbiotic partner who receives the request. This may at least in part cause further symbiotic partner membership predicate challenges, and/or notifications to other symbiotic partners, and/or it is possible that the requester could be kicked off of the network, among other possibilities. However, claimed subject matter is not intended to be so limited. Instead of or in addition to the result of the stamp verification operation producing a document authentication decision (as described above), if the verification is successful, this request may be replied to with the second layer document, data set, or message.

Turning back to FIG. 4, FIG. 4 depicts a further embodiment of a steganography method that may be employed in a symbiotic network. At block 401, the process may wait for a message to arrive. At block 402, a determination may be made as to whether a message is received. If one is received, a decision to take an initiative may be made, as depicted at block 403. At block 404, an initiative may be taken. At block 405, a determination may be made as to whether the initiative is successful. Block 406 depicts that if the initiative is successful, the recipient may read a next layer message. This process may be repeated for one or more additional layers. If further layers do not exist, the system may go back to block 401 and wait for another document to arrive. Embodiments in accordance with claimed subject matter may include all, less than all, or more than all of blocks 401-405. Further, the order of blocks 401-405 is merely an example order, and the scope of claimed subject matter is not limited in this respect.

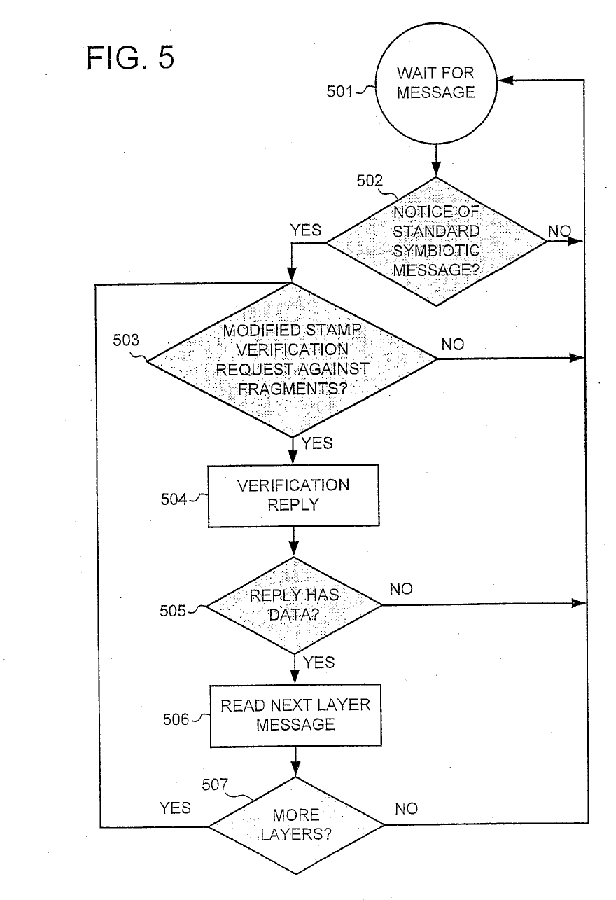

FIG. 5 depicts a further embodiment of a steganography method that may be employed in a symbiotic network. At block 501, a determination may be made as to whether a message is received. At block 502, a determination may be made as to whether a notice of a standard symbiotic message is received. If one is received, at block 503, a determination may be made as to whether a modified stamp verification request against fragments is requested. Block 504 shows that if this is requested, then a verification reply may be received. At block 505, a determination may be made as to whether the reply has data. Block 506 depicts that if the reply has data, the recipient may read a next layer message. At block 507, a determination may be made as to whether there are any more layers in the document. This process may be repeated for one or more additional layers. If further layers do not exist, the system may go back to block 501 and wait for a document to arrive.

Many variations may now be apparent to those skilled in the arts. For example, the layer two document may be shattered, with one or more fragments of the second layer document being associated with one or more of the fragments of the first layer document. The initiate( ) routine may require additional information beyond the fragment, such as a password. This method may be applied recursively, with layer three documents attached to fragments of layer two documents etc. The method may be combined with access control lists and host authentication to so that only certain symbiotic partners may access a second layer or higher layer document from the first layer. Furthermore, it may be allowed that a document is distributed to a non-member, as for document stamping, and that a member of the symbiotic network becomes a second layer (or higher) document retrieval agent. In which case, the retrieval agent would shatter the document, and retrieve the second layer data for the document holder.

Now, turning to FIG. 11, FIG. 11 depicts another embodiment of a steganographic method that may be employed in a symbiotic network. At Block 1101, a multi-layer document may be transmitted from a first computing platform to a second computing platform. The document may have two or more layers. Block 1102 shows that a first grouping of data elements may be transmitted to a verification agent. Block 1103 depicts that a second grouping of data elements may be provided to the verification agent from the second computing platform. At Block 1104, the first grouping of data elements and the second grouping of data elements may be compared. At block 1105, a determination may be made as to whether the first grouping of data elements and said second grouping of data elements are at least substantially the same. If they are at least substantially the same, at Block 1106, access may be given to at least a portion of the second layer document.

FIG. 12 illustrates an embodiment of a steganographic method that may be employed in a symbiotic network. At block 1201, a first grouping of data elements from a first computing platform may be read. The first grouping of data elements may comprise at least a subset of a document having at least a first layer and a second layer. At block 1202, a second grouping of data elements from a second computing platform may be read. The second grouping of data elements may be symbiotically related to the first grouping of data elements. Block 1203 depicts that the second grouping of data elements may be verified. This verification may include a comparison of the first and second groupings of data elements. At block 1204, a determination may be made as to whether the first grouping of data elements and the second grouping of data elements substantially the same. If they are substantially the same, at Block 1205, access may be provided to the second layer.

In various embodiments, verification may be made of one piece or fragment of a document, and/or some pieces or fragments of a document, and/or up to all pieces or fragments of a document.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of claimed subject matter is not limited in these respects. It should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of transmitting data on a symbiotic network comprising:
providing a first data set;
associating at least a portion of a second data set with at least a portion of said first data set, wherein said second data set is hidden unless access thereto is provided;
transmitting said portion of said first data set from a first computing platform to a second computing platform; and
providing access to said portion of said second data set if an initiating event occurs and said first and second computing platforms comprise a symbiotic pairing.

2. The method of claim 1 further comprising providing at least one meta marking indicating presence of said second data set.

3. The method of claim 1 wherein said initiating event comprises password authentication.

4. The method of claim 1 wherein said initiating event comprises an external protocol.

5. The method of claim 1 wherein said initiating event comprises host authentication.

6. The method of claim 1 wherein said initiating event comprises document verification for at least a portion of said first data set.

7. The method of claim 6 wherein said document verification comprises stamping verification.

8. The method of claim 6 wherein said document verification comprises watermarking verification.

9. The method of claim 1 further comprising:
associating at least a portion of a third data set with said at least a portion of said second data set, wherein said third data set is hidden until access is given thereto; and
providing access to said at least a portion of said third data set if a second initiating event occurs.

10. The method of claim 1 further comprising:
transmitting at least a portion of said second data set to said computing platform with said first data set as a second layer of said first data set.

11. The method of claim 1 wherein said if said initiating event does not occur within a predetermined time limit, access to said second data set is not given.

12. The method of claim 1 wherein access to said second data set is not given unless said initiating event occurs after a predetermined time limit or event.

13. The method of claim 1 wherein said initiating event comprises a triggering event and an initiating act, and wherein said second computing platform performs said initiating act at least partially in response to said triggering event.

14. A method of verifying data on a symbiotic network, comprising:
transmitting a document having at least a first layer and a second layer from a first computing platform to a second computing platform and transmitting a first grouping of data elements to a verification agent;
providing a second grouping of data elements to the verification agent from the second computing platform, wherein the first and second grouping of data elements comprise a symbiotic pair of groupings;
comparing the first grouping of data elements provided to the verification agent to the second grouping of data elements; and
if said first grouping of data elements and said second grouping of data elements are at least substantially the same, providing access to at least a portion of said second layer.

15. The method of claim 14 further comprising:
transmitting a third grouping of data elements corresponding to at least a portion of the second layer of the document from the first computing platform to said verification agent, wherein the third grouping of data elements comprises a stamp;
providing a fourth grouping of data elements to the verification agent from the second computing platform, wherein the fourth grouping of data elements corresponds to at least a portion of the second layer of the document, and wherein the third and fourth grouping of data elements comprise a symbiotic pair of groupings;
comparing the third grouping of data elements provided to the verification agent to the fourth grouping of data elements; and
if said third grouping of data elements and said fourth grouping of data elements are at least substantially the same, providing access to at least a portion of a third layer of said document.

16. The method of claim 14, further comprising:
shattering the document into a plurality of fragments, wherein one of the fragments comprises the first grouping of data elements; and
transmitting a subset of the plurality of fragments including the second grouping of data elements to the second computing platform.

17. The method of claim 14 wherein said comparing comprises validating at least one property of said first layer of the document.

18. The method of claim 14 wherein said document further comprises one or more meta marks indicating presence of said second layer.

19. The method of claim 14 wherein said comparing is performed at the request of the second computing platform, and further comprising verifying that the second computing platform posses permissions required to request said comparing.

20. The method of claim 14 wherein said verification agent comprises a member of said symbiotic network.

21. The method of claim 14 wherein said verification agent is located in an archival network.

22. A method of verifying data on a symbiotic network comprising:
reading a first grouping of data elements from a first computing platform, wherein the first grouping of data elements comprises at least a subset of a document having at least a first layer and a second layer;
reading a second grouping of data elements from a second computing platform, wherein said second grouping of data elements is symbiotically related to the first grouping of data elements;
verifying said second grouping of data elements by at least in part comparing said first grouping of data elements and said second grouping of data elements; and
providing access to said second layer if said first and second grouping of data elements are substantially the same.

23. The method of claim 22 further comprising shattering the document into a plurality of fragments.

24. The method of claim 22 wherein said shattering the documents comprises generating a symbiotic fragment.

25. The method of claim 22 further comprising reversing said shattering at least in part prior to said verifying.

26. A method of verifying data on a symbiotic network comprising:
providing at least a portion of a first layer of a document having said first layer and a second layer; and
providing access to said second layer at least partially in response to an initiating event;
wherein said initiating event comprises a symbiotic pairing verification of at least said portion of said first layer.

27. The method of claim 26 wherein said symbiotic pairing verification comprises:
reading a first grouping of data elements from a first computing platform, wherein the first grouping of data elements comprises at least a subset of said first layer of said document;
reading a second grouping of data elements from a second computing platform, wherein said second grouping of data elements originated from the first computing platform; and
verifying said second grouping of data elements by at least in part comparing said first grouping of data elements and said second grouping of data elements.

28. An article comprising: a storage medium having stored thereon instructions that, if executed, direct a computing platform to:
provide a first data set;
associate at least a portion of a second data set with at least a portion of said first data set; wherein said second data set is hidden unless access thereto is provided;
transmit at least a portion of said first data set from a first computing platform to a second computing platform; and
provide access to at least a portion of said second data set if an initiating event occurs and said first and second computing platforms comprise a symbiotic pairing.

29. The article of claim 28 further comprising: further instructions stored thereon that, if executed, further direct the computing platform to:
associate at least a portion of a third data set with said at least a portion of said second data set, wherein said third data set is hidden until access is given thereto; and
provide access to said at least a portion of said third data set if a second initiating event occurs.

30. An article comprising: a storage medium having stored thereon instructions that, if executed, direct a computing platform to:
read a first grouping of data elements from a first computing platform, wherein the first grouping of data elements comprises at least a subset of a document having at least a first layer and a second layer;
read a second grouping of data elements from a second computing platform, wherein said second grouping of data elements is symbiotically related to the first grouping of data elements;
verify said second grouping of data elements by at least in part comparing said first grouping of data elements and said second grouping of data elements; and
provide access to said second layer if said first and second grouping of data elements are substantially the same.

31. An apparatus comprising:
means for reading a first grouping of data elements from a first computing platform, wherein the first grouping of data elements comprises at least a subset of a document having at least a first layer and a second layer;
means for reading a second grouping of data elements from a second computing platform, wherein said second grouping of data elements is symbiotically related to the first grouping of data elements;
means for verifying said second grouping of data elements by at least in part comparing said first grouping of data elements and said second grouping of data elements; and
means for providing access to said second layer if said first and second grouping of data elements are substantially the same.
